(19) United States
(12) Patent Application Publication
(10) Pub. No.: US 2026/0024276 A1
(43) Pub. Date: Jan. 22, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventor: Dikai FAN, Beijing (CN)

(21) Appl. No.: 18/993,312

(22) PCT Filed: Aug. 29, 2023
(86) PCT No.: PCT/CN2023/115438

§ 371 Date: Jan. 10, 2025

(30) Foreign Application Priority Data
Sep. 15, 2022 (CN) 202211122991.1

(51) Int. Cl. G06T 15/50; G06T 7/50; G06T 7/90; G06T 15/04; G06T 19/00

(52) U.S. Cl. CPC G06T 15/506; G06T 7/50; G06T 7/90; G06T 15/04; G06T 19/00; G06T 2207/10024; G06T 2207/10028; G06T 2207/30244

(57) ABSTRACT

Embodiments of the present disclosure relate to an image processing method and apparatus, a device, and a medium, where the method includes: obtaining an environmental keyframe image and a corresponding depth image captured by an extended reality device; determining a lighting model based on the environmental keyframe image and the depth image; and rendering an extended reality object to be rendered based on the lighting model.

### CROSS-REFERENCE TO RELATED APPLICATION(S)

The present application is based on and claims priorities to Chinese Patent Application No. 202211122991.1, filed on Sep. 15, 2022, and PCT International patent application No. PCT/CN2023/115438 filed on Aug. 29, 2023, which are incorporated herein by reference in their entireties.

### TECHNICAL FIELD

The present disclosure relates to the field of image processing technologies, and in particular, to an image processing method and apparatus, a device, and a medium.

### BACKGROUND

With the development of technologies, human-computer interaction methods such as virtual reality (VR), augmented reality (AR), and mixed reality (MR) are applied to various scenarios.

In the related art, for an MR scenario, a virtual object needs to be inserted into a scene for display, and an extended reality object is displayed based only on a viewpoint of a camera, without considering factors such as lighting intensity and lighting colors in the scene, resulting in a poor reproduction of a displayed result and affecting an immersive experience of the mixed reality application.

### SUMMARY

To solve the above technical problems or at least partially solve the above technical problems, the present disclosure provides an image processing method and apparatus, a device, and a medium.

An embodiment of the present disclosure provides an image processing method. The method includes:
obtaining an environmental keyframe image and a corresponding depth image captured by an extended reality device;
determining a lighting model based on the keyframe image and the depth image; and
rendering an extended reality object to be rendered based on the lighting model.

An embodiment of the present disclosure further provides an image processing apparatus. The apparatus includes:
an obtaining module configured to obtain an environmental keyframe image and a corresponding depth image captured by an extended reality device:
a processing module configured to determine a lighting model based on the keyframe image and the depth image; and
a rendering module configured to render an extended reality object to be rendered based on the lighting model.

An embodiment of the present disclosure further provides an electronic device. The electronic device includes: a processor; and a memory configured to store executable instructions for the processor; the processor being configured to read the executable instructions from the memory, and execute the instructions to implement the image processing method provided in the embodiment of the present disclosure.

An embodiment of the present disclosure further provides a computer-readable storage medium. The storage medium stores a computer program, and the computer program is configured to implement the image processing method provided in the embodiment of the present disclosure.

An embodiment of the present disclosure further provides a computer program product, including: a computer program/instruction, where the computer program/instruction, when executed by a processor, implements the image processing method described in any one of the embodiments of the present disclosure.

In the image processing method and apparatus and the storage medium in the embodiments of the present disclosure, an environmental keyframe image and a corresponding depth image captured by an extended reality device are obtained, a lighting model is determined based on the environmental keyframe image and the depth image, and an extended reality object to be rendered is rendered based on the lighting model. With the above technical solution, an image of an environmental scene at which an extended reality device is located is obtained by the extended reality device, and a corresponding lighting model is determined based on the image. Based on the lighting model, lighting of a real scene can be reproduced, and materials of the real scene can be recovered, to implement a more realistic extended reality scene such as a virtual reality scene, a mixed reality scene, and an augmented reality scene, thereby further improving an immersive experience of extended reality application scenarios.

### BRIEF DESCRIPTION OF THE DRAWINGS

The above and other features, advantages, and aspects of embodiments of the present disclosure become more apparent with reference to the following specific embodiments in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of an image processing method according to some embodiments of the present disclosure;

FIG. 2 is a schematic flowchart of another image processing method according to some embodiments of the present disclosure:

FIG. 3 is a schematic diagram of a structure of an image processing apparatus according to some embodiments of the present disclosure; and

FIG. 4 is a schematic diagram of a structure of an electronic device according to some embodiments of the present disclosure.

### DETAILED DESCRIPTION OF EMBODIMENTS

Embodiments of the present disclosure are described in more details below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this regard.

The term “include/comprise” used herein and the variations thereof are an open-ended inclusion, that is, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit an order or interdependence of functions performed by these apparatuses, modules, or units.

Names of messages or information exchanged between a plurality of apparatuses in the implementations of the present disclosure are used for illustrative purposes only, and are not used to limit the scope of these messages or information.

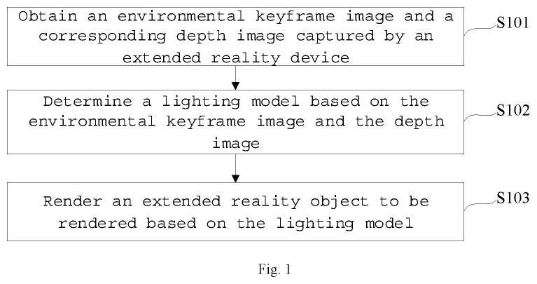

FIG. 1 is a schematic flowchart of an image processing method according to some embodiments of the present disclosure. The method may be performed by an image processing apparatus, where the apparatus may be implemented by software and/or hardware, and is generally integrated into an electronic device. As shown in FIG. 1, the method includes the following steps.

Step 101: Obtain an environmental keyframe image and a corresponding depth image captured by an extended reality device.

The extended reality device may be any device related to virtual reality, augmented reality, or mixed reality. The form of the extended reality device is not limited in the embodiments of the present disclosure. For example, the extended reality device may be a head-mounted display device or AR glasses. The environmental scene refers to a scene of a space at which the extended reality device worn by a user is located, such as a small room. The environmental keyframe image refers to a color image, for example, an RGB image or a grayscale image, captured of the environmental scene. The depth image refers to an image with three-dimensional depth feature information captured of the environmental scene.

In some embodiments, there are usually a plurality of environmental keyframe images and depth images.

In some embodiments of the present disclosure, there are many manners of obtaining the environmental keyframe image and the corresponding depth image captured by the extended reality device. In some implementations, upon rotation of the extended reality device by a preset angle each time, the environmental scene is captured to obtain the environmental keyframe image and the corresponding depth image.

In some other implementations, each shooting position is preset, and the extended reality device is controlled to perform shooting at each shooting position to obtain the environmental keyframe image and the corresponding depth image. The above two manners are only examples of obtaining the environmental keyframe image and the corresponding depth image captured by the extended reality device. The present disclosure does not limit a specific manner of obtaining the environmental keyframe image and the corresponding depth image captured by the extended reality device.

Specifically, during a process in which the user wears the extended reality device, the extended reality device may be controlled to rotate in the environmental scene, and upon rotation of the extended reality device by the preset angle each time, the environmental scene is captured to obtain the environmental keyframe image and the corresponding depth image.

Step 102: Determine a lighting model based on the environmental keyframe image and the depth image.

In some embodiments of the present disclosure, there are many manners of determining the lighting model based on the environmental keyframe image and the depth image. In some implementations, the environmental keyframe image is processed to obtain a radiance map, and the depth image is processed to obtain a normal vector map, calculation is performed based on a preset internal parameter matrix and pixel coordinates of the radiance map to obtain a direction vector of a texture model, a pixel radiance value is determined based on the radiance map, and a normal vector is obtained based on the normal vector map. Calculation is performed based on the pixel radiance value, the direction vector, and the normal vector to obtain a lighting intensity and a lighting color of each azimuth coordinate of the texture model, and the lighting model is determined based on the lighting intensity and the lighting color of each azimuth coordinate of the texture model. In some embodiments, the preset texture model may be selected and set according to an application scenario, for example, a hemisphere model.

In some other implementations, all depth maps are converted to standard position coordinates, a radiance map corresponding to the environmental keyframe image is obtained, all radiance maps are converted to the standard position coordinates, a normal vector map corresponding to the depth map is obtained, the direction vector of the texture model is determined based on the radiance map, and finally, the lighting intensity and the lighting color of each azimuth coordinate of the texture model are calculated based on a pixel radiance value of the radiance map, a normal vector of the normal vector map, and the direction vector to obtain the lighting model. The standard position may be set as required, for example, a position of the extended reality object to be rendered is used as the standard position.

In some embodiments of the present disclosure, after the environmental keyframe image and the corresponding depth image are obtained, the lighting model may be determined based on the environmental key frame image and the depth image.

Step 103: Render the extended reality object to be rendered based on the lighting model.

The extended reality object to be rendered refers to an extended reality object to be displayed in an extended reality scene. The extended reality object to be rendered may be selected and set according to an application scenario, for example, a chair is selected as the extended reality object to be rendered in the extended reality scene, or a pot of flowers is selected as the extended reality object to be rendered in the extended reality scene.

In some embodiments of the present disclosure, rendering the extended reality object to be rendered based on the lighting model may be understood as sending the lighting model including environmental lighting (the lighting intensity and the lighting color) to a rendering engine, and the rendering engine renders the extended reality object to be rendered based on the lighting model.

In the image processing solution provided in the embodiments of the present disclosure, the environmental keyframe image and the corresponding depth image captured by the extended reality device are obtained, the lighting model is determined based on the environmental keyframe image and the depth image, and the extended reality object to be rendered is rendered based on the lighting model. With the above technical solution, the image of the environmental scene at which the extended reality device is located is obtained by the extended reality device, and the corresponding lighting model is determined based on the image. Based on the lighting model, lighting of a real scene can be reproduced, and materials of the real scene can be recovered, to implement a more realistic extended reality scene such as a virtual reality scene, a mixed reality scene, and an augmented reality scene, thereby further improving an immersive experience of an extended reality application scene.

In some embodiments, obtaining the environmental keyframe image and the corresponding depth image captured by the extended reality device includes: upon rotation of the extended reality device by a preset angle each time, capturing the environmental scene to obtain the environmental keyframe image and the depth image.

Specifically, after an extended reality device, for example, a head-mounted display device or AR glasses, starts to work normally, an angle rotated by a user is recorded, for example, one frame of RGB image (the environmental keyframe image) and one depth map are selected every five degrees.

In this way, the environmental keyframe image and the depth image at different angles can be obtained by means of angle rotation, so that the lighting intensity and the lighting color at different angles are used as a lighting environment, thereby improving the accuracy of a subsequent lighting model and finally ensuring the authenticity of a rendering result to meet a user requirement.

In some embodiments, determining the lighting model based on the keyframe image and the depth image includes: processing the environmental keyframe image to obtain a radiance map, and processing the depth image to obtain a normal vector map: calculating based on a preset internal parameter matrix and pixel coordinates of the radiance map to obtain a direction vector of a texture model: determining a pixel radiance value based on the radiance map, and obtaining a normal vector based on the normal vector map: calculating based on the pixel radiance value, the direction vector, and the normal vector to obtain a lighting intensity and a lighting color of each azimuth coordinate of the texture model; and determining the lighting model based on the lighting intensity and the lighting color of each azimuth coordinate of the texture model.

In some embodiments of the present disclosure, before the depth image is processed to obtain the normal vector map, the method further includes: obtaining a shooting position corresponding to the radiance map and the depth map, and in response to the shooting position being not a preset standard position, converting coordinates of the radiance map and of the depth image to obtain a new radiance map and a new depth image, and using the new radiance map as the radiance map and using the new depth image as the depth image for subsequent processing.

In some embodiments of the present disclosure, the standard position may be set according to an application scenario, for example, a position of the extended reality object to be rendered. In order to ensure the accuracy of subsequent calculation, the radiance map and the depth map that are not at the standard position need to be converted to the standard position image coordinates for calculation.

In some embodiments of the present disclosure, processing the environmental keyframe image to obtain the radiance map includes: obtaining a color channel corresponding to the environmental keyframe image, and processing the color channel based on a calibration mapping table corresponding to each color channel to obtain the radiance map.

In some embodiments of the present disclosure, processing the depth image to obtain the normal vector map includes: calculating, based on depth values and pixel coordinates of the depth image, a normal vector on a three-dimensional space object corresponding to each pixel to obtain the normal vector map.

Specifically, an offline calibration process, that is, photometric calibration, needs to be performed on a camera of the extended reality device in advance. The main purpose is to remove an impact of camera exposure on imaging, to obtain a radiance map. More specifically, when the keyframe image is an RGB image, photometric calibration is separately performed on three color channels of the RGB image, to obtain different calibration mapping tables for the three color channels, which are used for preprocessing of the RGB image to obtain radiance maps of the three color channels. When the keyframe image is a grayscale image, photometric calibration is performed on a color channel of the grayscale image to obtain one calibration mapping table, which is used for preprocessing of the grayscale image to obtain one radiance map.

In other words, for the RGB image, the color image with three color channels is mapped to the radiance map based on the calibration mapping table for each color channel. For the depth map, the normal vector on the three-dimensional space object corresponding to each pixel is calculated based on the depth value and the pixel coordinates to obtain the normal vector map.

Specifically, for the standard position, the radiance map is attached to the texture model (for example, the hemisphere model) based on the radiance map and the normal vector map.

The hemisphere model is used as an example for description. It is usually considered that the environment is not a real sphere or cube, and the environment is modeled with reference to the hemisphere model. A direction vector f of each point on the hemisphere model may be obtained by normalizing a pixel after the pixel is projected onto a normalization plane, as shown in formula (1):

$$f = N ( {{K}^{- 1} ( u , v , 1 )}^{T} ) \qquad ( 1 )$$

where K represents a camera internal parameter matrix: u, v represent an x coordinate and a y coordinate of an image, respectively; and a function N represents normalizing a vector (that is, changing a modulus length to 1).

Specifically, a pixel radiance value corresponding to a pixel (u, v) is obtained by multiplying a lighting color value (material) at a spherical surface of the hemisphere model by a lighting intensity value (light intensity), and then multiplying a cosine of n and f, the pixel radiance value is denoted as E(u, v), the light intensity is denoted as I(α, β), and the material is denoted as C(α, β), as shown in formula (2):

$$E ( u , v ) = I ( α , β ) C ( α , β ) \vert < n , f > \vert \qquad ( 2 )$$

In formula (2), |<n, f>| represents an absolute value of an inner product of two vectors n and f, and (α, β) represents a hemisphere azimuth coordinate.

Based on the foregoing description, coordinate conversion also needs to be performed for the non-standard position. In other words, for the non-standard position, in addition to rotation, the camera is also subject to a translation. Therefore, in the texture mapping process, an impact of translation of the camera relative to the standard position needs to be eliminated.

Specifically, an image frame represented by the standard position is denoted as w, and a current camera frame is denoted as c. Projection of a depth map and a current frame image of the camera to the standard position is shown in formula (3):

$$P = {R}_{wc} {{K}^{- 1} ( u , v , 1 )}^{T} d ( u , v ) + {t}_{wc} \qquad ( 3 )$$

where P represents coordinate values of a point observed in the current frame in the standard frame, d(u, v) represents a value of a pixel coordinate of a depth image (u, v), R_{wc} represents rotation from c to w, and t_{wc} represents translation from c to w. Formula (3) is a coordinate transformation formula for the point.

Specifically, as shown in formulas (4) and (5):

$$\hat{u} = {f}_{x} \frac{{P}_{x}}{{P}_{z}} + {c}_{x} \qquad ( 4 )$$

$$\hat{v} = {f}_{y} \frac{{P}_{y}}{{P}_{z}} + {c}_{y} \qquad ( 5 )$$

where û, \hat{v} represent pixel coordinate values of the image at the standard position, and Pₓ, P_{y}, P_{z} represent x, y, z values of a point P, respectively.

Specifically, in a pixel coordinate system û, û, a depth value obtained at the standard position is shown in formula (6):

$$\hat{d} ( \hat{u} , \hat{v} ) = {P}_{z} \qquad ( 6 )$$

Specifically, in a pixel coordinate system û, \hat{v}, an intensity value obtained at the standard position is shown in formula (7):

$$\hat{E} ( \hat{u} , \hat{v} ) = E ( u , v ) \qquad ( 7 )$$

According to the foregoing formulas (6) and (7), a new depth map and a new radiance map at the standard position after translation is eliminated may be generated, and then a texture mapping operation is performed.

After all azimuths α, β are covered, for all texture mapping relationships, that is, as shown in formula (2), a globally optimal I(α, β) and c(α, β) need to be calculated.

In this embodiment of the present disclosure, a to-be-solved lighting function is established based on the pixel radiance value, the direction vector, the normal vector, the lighting intensity, and the lighting color, the to-be-solved lighting function is converted to obtain a target lighting function, a target energy function is obtained based on the target lighting function and discretized azimuth degrees, and the target energy function is calculated to obtain the lighting intensity and the lighting color of each azimuth coordinate of the texture model.

Specifically, the to-be-solved lighting function is established based on the pixel radiance value, the direction vector, the normal vector, the lighting intensity, and the lighting color, as shown in formula (2). Known values are E(u, v) and |<n, f>|, and unknown values are I(α, β) and C(α, β). For the light intensity I, it may be considered that the light intensity is substantially uniform indoors, that is, an azimuth change does not cause a large brightness change. For the material C, it may be considered that there are only a limited number of materials indoors, and a solution of the material is sparse. The material may be understood as different colors generated when light irradiates different objects.

Specifically, a logarithm is taken for formula (2), to convert multiplication into addition, where i is a constant, to obtain formulas (8) to (10):

$$I ( α , β ) C ( α , β ) = \frac{E ( u , v )}{\vert < n , f > \vert} = {e}^{{λ}_{i} ( α , β )} \qquad ( 8 )$$

$$ln I ( α , β ) + ln C ( α , β ) = {λ}_{i} ( α , β ) \qquad ( 9 )$$

$$i ( α , β ) + c ( α , β ) = {λ}_{i} ( α , β ) \qquad ( 10 )$$

Specifically, the azimuth degrees are discretized, a value of a ranges from 0 to 360 degrees, and a value of β ranges from 0 to 90 degrees. For example, a value is taken for a every three degrees, which is denoted as αₚ. A value is taken for β every degree, which is denoted as β_{q}. Settings are shown in formula (11):

$${i}_{p , q} = i ( {α}_{p} , {β}_{q} ) , {c}_{p , q} = c ( {α}_{p} , {β}_{q} ) , {λ}_{i}^{p , q} = {λ}_{i} ( {α}_{p} , {β}_{q} ) \qquad ( 11 )$$

In this way, a target energy function F is obtained, as shown in formula (12):

$$F = {\sum }_{p , q} {( {i}_{p , q} + {c}_{p , q} - {λ}_{i}^{p , q} )}^{2} + μ ( {( {i}_{p , q} - {i}_{p + 1 , q} )}^{2} + {( {i}_{p , q} - {i}_{p , q + 1} )}^{2} ) + v ( \vert {c}_{p , q} - {c}_{p + 1 , q} \vert + \vert {c}_{p , q} - {c}_{p , q + 1} \vert ) \qquad ( 12 )$$

In formula 12, the first term of a loss function represents measurement data, the second term represents that lighting is substantially uniform, and the third term represents that the material is sparse. The target energy function may be solved by using, for example, an alternating direction method of multipliers, to optimally obtain i_{p,q} and c_{p,q}. Finally, an exponent is calculated to obtain the final lighting intensity and the final lighting color (material).

In this way, the lighting intensity and the lighting color are determined based on images at different angles of the environmental scene at which the extended reality device is located, so that the lighting model is determined based on the lighting intensities and the lighting colors. Based on the lighting model, lighting of a real scene can be reproduced, and a material of the real scene can be recovered, to implement a more realistic extended reality scene, thereby further improving an immersive experience of extended reality application scenes.

FIG. 2 is a schematic flowchart of another image processing method according to some embodiments of the present disclosure. This embodiment further optimizes the foregoing image processing method based on the foregoing embodiment. As shown in FIG. 2, the method includes the following steps.

Step 201: Upon rotation of the extended reality device by a preset angle each time, capture the environmental scene to obtain the environmental keyframe image and the depth image.

For example, an extended reality device is AR glasses, and an environmental scene is room A. A user wears the AR glasses and controls the AR glasses to start to work. The AR glasses are controlled to rotate by a preset angle, and a corresponding environmental keyframe image and a corresponding depth image are obtained each time the AR glasses are rotated by a specific angle. For example, room A is captured every five degrees of rotation, to obtain the environmental keyframe image and the depth image.

Step 202: Obtain a color channel corresponding to the environmental keyframe image, and process the color channel based on a calibration mapping table corresponding to each color channel to obtain the radiance map.

For example, the environmental keyframe image is an RGB image, and includes three RGB color channels. Three calibration mapping tables corresponding to RGB are separately obtained, and are denoted as a calibration mapping table 1, a calibration mapping table 2, and a calibration mapping table 3. An R color channel is processed based on the calibration mapping table 1, to obtain a radiance map a1: a G color channel is processed based on the calibration mapping table 2, to obtain a radiance map a2; and a B color channel is processed based on the calibration mapping table 3, to obtain a radiance map a3. In this way, three radiance maps a1, a2, and a3 are obtained for one RGB image.

Step 203: Obtain a shooting position corresponding to the radiance map and the depth map, and when the shooting position is not a preset standard position, convert coordinates of the radiance map and of the depth image to obtain a new radiance map and a new depth image, and use the new radiance map as the radiance map and use the new depth image as the depth image for subsequent processing.

In some embodiments of the present disclosure, the standard position may be set according to an application scenario, for example, a position of the extended reality object to be rendered. In order to ensure the accuracy of subsequent calculation, the radiance map and the depth map that are not at the standard position need to be converted to the standard position image coordinates for calculation. In other words, for the non-standard position, the new radiance map and the new depth image are used for subsequent calculation and processing.

Step 204: Calculate, based on depth values and pixel coordinates of the depth image, a normal vector on a three-dimensional space object corresponding to each pixel to obtain the normal vector map.

Specifically, for the depth map, the normal vector on the three-dimensional space object corresponding to each pixel is calculated based on the depth value and the pixel coordinates to obtain the normal vector map.

Step 205: Calculate based on a preset internal parameter matrix and pixel coordinates of the radiance map to obtain a direction vector of the texture model.

Step 206: Determine a pixel radiance value based on the radiance map, and obtain a normal vector based on the normal vector map.

Step 207: Calculate based on the pixel radiance value, the direction vector, and the normal vector to obtain lighting intensity and lighting color of each azimuth coordinate of the texture model, and determine the lighting model based on the lighting intensity and the lighting color of each azimuth coordinate of the texture model.

In some embodiments of the present disclosure, a to-be-solved lighting function is established based on the pixel radiance value, the direction vector, the normal vector, the lighting intensity, and the lighting color, the to-be-solved lighting function is converted to obtain a target lighting function, a target energy function is obtained based on the target lighting function and discretized azimuth degrees, and the target energy function is calculated to obtain the lighting intensity and the lighting color of each azimuth coordinate of the texture model.

The preset internal parameter matrix may be a camera internal parameter matrix. The direction vector of each point on the texture model may be calculated based on the pixel coordinates of the image and the internal parameter matrix. In addition, the pixel radiance value is determined based on the radiance map, and the normal vector is obtained based on the normal vector map. In this way, calculation is performed based on the pixel radiance value, the direction vector, and the normal vector to obtain the lighting intensity and the lighting color of each azimuth coordinate of the texture model, and the lighting model is determined based on the lighting intensity and the lighting color of each azimuth coordinate of the texture model.

Step 208: Render the extended reality object to be rendered based on the lighting model.

The extended reality object to be rendered refers to an extended reality object to be displayed in an extended reality scene. The extended reality object to be rendered may be selected and set according to an application scenario. For example, a chair is selected as the extended reality object to be rendered in the extended reality scene, or a pot of flowers is selected as the extended reality object to be rendered in the extended reality scene.

In some embodiments of the present disclosure, rendering the extended reality object to be rendered based on the lighting model to obtain an extended reality scene may be understood as sending the lighting model including environmental lighting (the lighting intensities and the lighting colors) to a rendering engine, and the rendering engine renders the extended reality object to be rendered based on the lighting model.

In the image processing solution provided in the embodiments of the present disclosure, upon rotation of the extended reality device by a preset angle each time, the environmental scene is captured to obtain the environmental keyframe image and the depth image, a color channel corresponding to the environmental keyframe image is obtained, and processing is performed based on each color channel and a corresponding pre-calibration mapping table to obtain the radiance map. A shooting position corresponding to the radiance map and the depth map is obtained. When the shooting position is not a preset standard position, coordinate conversion is performed on the radiance map and the depth image to obtain a new radiance map and a new depth image. A normal vector on a three-dimensional space object corresponding to each pixel is calculated based on depth values and pixel coordinates of the depth image to obtain the normal vector map. Calculation is performed based on a preset internal parameter matrix and pixel coordinates of the radiance map to obtain a direction vector of the texture model. A pixel radiance value is determined based on the radiance map, and a normal vector is obtained based on the normal vector map. Calculation is performed based on the pixel radiance value, the direction vector, and the normal vector to obtain a lighting intensity and a lighting color of each azimuth coordinate of the texture model, and the lighting model is determined based on the lighting intensity and the lighting color of each azimuth coordinate of the texture model. The extended reality object to be rendered is rendered based on the lighting model. With the above technical solution, lighting of an extended reality scene such as an MR scene can be reproduced, and a material of a real scene can be recovered, to implement a more realistic extended reality scene. In other words, after image samplings in different directions are obtained by using a device such as a head-mounted display device, a better environmental lighting and environmental material model of a scene, for example, a small room, can be restored. This is friendly to scenes such as VR/AR, and can bring a better immersive experience for extended reality applications.

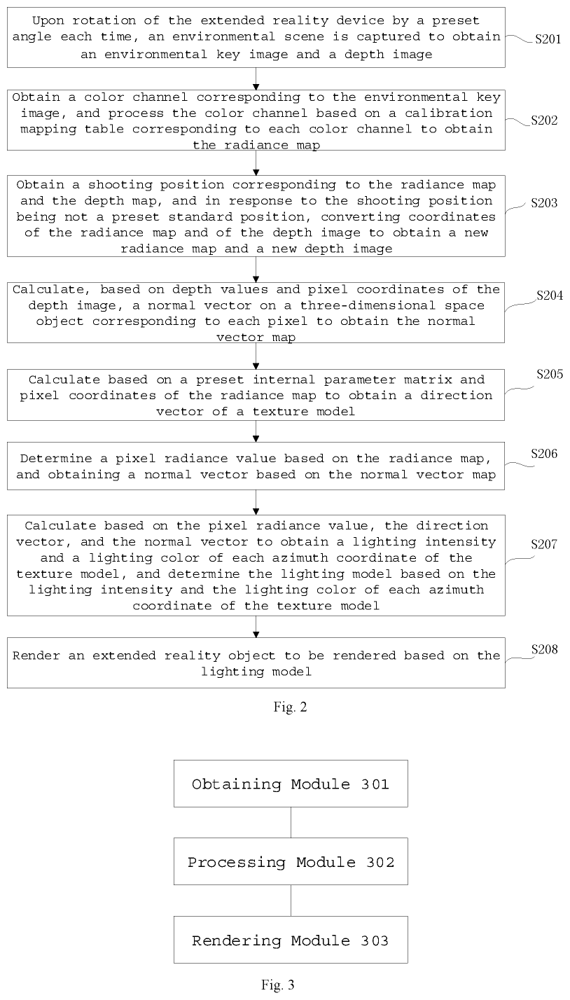

FIG. 3 is a schematic diagram of a structure of an image processing apparatus provided in some embodiments of the present disclosure. The apparatus may be implemented by software and/or hardware, and is generally integrated into an electronic device. As shown in FIG. 3, the apparatus includes:
an obtaining module 301, configured to obtain an environmental keyframe image and a corresponding depth image captured by an extended reality device;
a processing module 302, configured to determine a lighting model based on the keyframe image and the depth image; and
a rendering module 303, configured to render an extended reality object to be rendered based on the lighting model.

Optionally, the obtaining module 301 is specifically configured to:
upon rotation of the extended reality device by a preset angle each time, capture an environmental scene to obtain the environmental keyframe image and the depth image.

Optionally, the processing module 302 includes:
a first processing unit, configured to process the environmental keyframe image to obtain a radiance map;
a second processing unit, configured to process the depth image to obtain a normal vector map;
a calculation unit, configured to calculate based on a preset internal parameter matrix and pixel coordinates of the radiance map to obtain a direction vector of a texture model;
a determination and obtaining unit, configured to determine a pixel radiance value based on the radiance map, and obtain a normal vector based on the normal vector map;
the calculation unit, configured to calculate based on the pixel radiance value, the direction vector, and the normal vector to obtain a lighting intensity and a lighting color of each azimuth coordinate of the texture model; and
a determination unit, configured to determine the lighting model based on the lighting intensity and the lighting color of each azimuth coordinate of the texture model.

Optionally, the processing module 302 further includes:
an obtaining unit, configured to obtain a shooting position corresponding to the radiance map and the depth map; and
a conversion unit, configured to, in response to the shooting position being not a preset standard position, convert coordinates of the radiance map and of the depth image to obtain a new radiance map and a new depth image, and use the new radiance map as the radiance map and use the new depth image as the depth image for subsequent processing.

Optionally, the first processing unit is specifically configured to:
obtain a color channel corresponding to the environmental keyframe image, and process the color channel based on a calibration mapping table corresponding to each color channel to obtain the radiance map.

Optionally, the second processing unit is specifically configured to:
calculate, based on depth values and pixel coordinates of the depth image, a normal vector on a three-dimensional space object corresponding to each pixel to obtain the normal vector map.

Optionally, the calculation unit is specifically configured to:
establish a to-be-solved lighting function based on the pixel radiance value, the direction vector, the normal vector, the lighting intensity, and the lighting color:
convert the to-be-solved lighting function to obtain a target lighting function:
obtain a target energy function based on the target lighting function and discretized azimuth degrees; and
calculate the target energy function to obtain the lighting intensity and the lighting color of each azimuth coordinate of the texture model.

The image processing apparatus provided in the embodiments of the present disclosure may perform the image processing method provided in any one of the embodiments of the present disclosure, and has corresponding functional modules and beneficial effects for performing the method.

It should be noted that in the embodiment of the image processing apparatus, the included modules are divided according to functional logic, but are not limited to the foregoing division, as long as corresponding functions can be implemented. In addition, specific names of the functional modules are only used to distinguish the modules from each other, and are not used to limit the scope of protection of the present disclosure. The foregoing modules may be implemented as software components that are executed on one or more general-purpose processors, or may be implemented as hardware such as a programmable logic device and/or a special-purpose integrated circuit for performing some functions. In some embodiments, the modules may be implemented in the form of a software product that may be stored in a non-volatile storage medium. The non-volatile storage medium includes instructions for causing a computer device (for example, a personal computer, a server, a network device, or a mobile terminal) to perform the method described in the embodiments of the present disclosure. In some embodiments, the foregoing modules may be implemented on a single device, or may be distributed on a plurality of devices. Functions of the modules may be combined with each other, or may be further split into a plurality of submodules.

Some embodiments of the present disclosure further provide a computer program product, including a computer program/instruction, where the computer program/instruction, when executed by a processor, implements the image processing method provided in any one of the embodiments of the present disclosure.

Some embodiments of the present disclosure further provide a computer program/instruction, where the computer program/instruction, when executed by a processor, implements the image processing method provided in any one of the embodiments of the present disclosure.

Some embodiments of the present disclosure further provide an electronic device. The electronic device may include a processing apparatus and a storage apparatus. The storage apparatus may be configured to store an executable instruction. The processing apparatus may be configured to read the executable instruction from the storage apparatus, and execute the executable instruction to implement the image processing method in the foregoing embodiments.

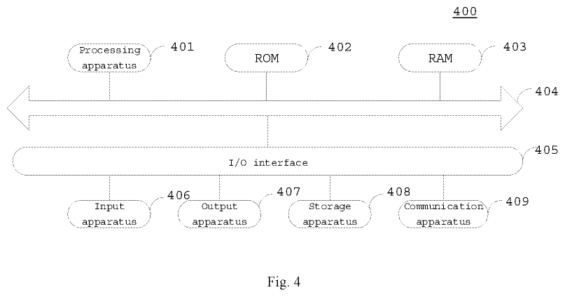

FIG. 4 is a schematic diagram of a structure of an electronic device provided in some embodiments of the present disclosure. Referring specifically to FIG. 4, FIG. 4 shows a schematic diagram of a structure suitable for an electronic device 400 in the embodiments of the present disclosure. The electronic device 400 in the embodiments of the present disclosure may include but is not limited to mobile terminals such as a mobile phone, a notebook computer, a digital broadcast receiver, a personal digital assistant (PDA), a tablet computer (PAD), and a portable media player (PMP), and fixed terminals such as a digital television (TV) and a desktop computer. The electronic device shown in FIG. 4 is merely an example, and shall not impose any limitation on the function and scope of use of the embodiments of the present disclosure.

As shown in FIG. 4, the electronic device 400 may include a processing apparatus (for example, a central processor, a graphics processor, etc.) 401 that may perform a variety of appropriate actions and processing in accordance with a program stored in a read-only memory (ROM) 402 or a program loaded from a storage apparatus 408 into a random access memory (RAM) 403. The RAM 403 further stores various programs and data required for the operation of the electronic device 400. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touch screen, a touchpad, a keyboard, a mouse, a camera, a microphone, an accelerometer, and a gyroscope: an output apparatus 407 including, for example, a liquid crystal display (LCD), a speaker, and a vibrator; the storage apparatus 408 including, for example, a tape and a hard disk; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 409 and installed, installed from the storage apparatus 408, or installed from the ROM 402. When the computer program is executed by the processing apparatus 401, the above-mentioned functions defined in the image processing method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (Electrically Erasable Programmable read only memory, EPROM or flash memory), an optic fiber, a portable compact disk read-only memory (Compact Disc Read-Only Memory, CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (Radio Frequency, RF), etc., or any suitable combination thereof.

In some implementations, the client and the server may communicate by using any currently known or future-developed network protocol such as a hypertext transfer protocol (HTTP), and may be connected to digital data communication (for example, a communication network) in any form or medium. Examples of the communication network include a local area network (Local Area Network, “LAN”), a wide area network (Wide Area Network, “WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs, and when the one or more programs are executed by the electronic device, the electronic device is caused to: obtain an environmental keyframe image and a corresponding depth image captured by an extended reality device; determine a lighting model based on the environmental keyframe image and the depth image; and render an extended reality object to be rendered based on the lighting model.

In some embodiments of the present disclosure, computer program code for performing operations in the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip system (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides an image processing method, including:
obtaining an environmental keyframe image and a corresponding depth image captured by an extended reality device:
determining a lighting model based on the environmental keyframe image and the depth image; and
rendering an extended reality object to be rendered based on the lighting model.

According to one or more embodiments of the present disclosure, in the image processing method provided in the present disclosure, the obtaining an environmental keyframe image and a corresponding depth image captured by an extended reality device includes:
upon rotation of the extended reality device by a preset angle each time, capturing an environmental scene to obtain the keyframe image and the depth image.

According to one or more embodiments of the present disclosure, in the image processing method provided in the present disclosure, the determining a lighting model based on the environmental keyframe image and the depth image includes:
processing the environmental keyframe image to obtain a radiance map, and processing the depth image to obtain a normal vector map:
calculating based on a preset internal parameter matrix and pixel coordinates of the radiance map to obtain a direction vector of a texture model:
determining a pixel radiance value based on the radiance map, and obtaining a normal vector based on the normal vector map:
calculating based on the pixel radiance value, the direction vector, and the normal vector to obtain a lighting intensity and a lighting color of each azimuth coordinate of the texture model; and
determining the lighting model based on the lighting intensity and the lighting color of each azimuth coordinate of the texture model.

According to one or more embodiments of the present disclosure, in the image processing method provided in the present disclosure, before the processing the depth image to obtain the normal vector map, the image processing method further includes:
obtaining a shooting position corresponding to the radiance map and the depth map; and
in response to the shooting position being not a preset standard position, converting coordinates of the radiance map and of the depth image to obtain a new radiance map and a new depth image, and using the new radiance map as the radiance map and using the new depth image as the depth image.

According to one or more embodiments of the present disclosure, in the image processing method provided in the present disclosure, the processing the environmental keyframe image to obtain the radiance map includes:
obtaining a color channel corresponding to the environmental keyframe image, and processing the color channel based on a calibration mapping table corresponding to each color channel to obtain the radiance map.

According to one or more embodiments of the present disclosure, in the image processing method provided in the present disclosure, the processing the depth image to obtain the normal vector map includes:
calculating, based on depth values and pixel coordinates of the depth image, a normal vector on a three-dimensional space object corresponding to each pixel to obtain the normal vector map.

According to one or more embodiments of the present disclosure, in the image processing method provided in the present disclosure, the calculating based on the pixel radiance value, the direction vector, and the normal vector to obtain the lighting intensity and the lighting color of each azimuth coordinate of the texture model includes:
establishing a to-be-solved lighting function based on the pixel radiance value, the direction vector, the normal vector, the lighting intensity, and the lighting color;
converting the to-be-solved lighting function to obtain a target lighting function;
obtaining a target energy function based on the target lighting function and discretized azimuth degrees; and
calculating the target energy function to obtain the lighting intensity and the lighting color of each azimuth coordinate of the texture model.

According to one or more embodiments of the present disclosure, the present disclosure provides an image processing apparatus, including:
an obtaining module, configured to obtain an environmental keyframe image and a corresponding depth image captured by an extended reality device;
a processing module, configured to determine a lighting model based on the environmental keyframe image and the depth image; and
a rendering module, configured to render an extended reality object to be rendered based on the lighting model.

According to one or more embodiments of the present disclosure, in the image processing apparatus provided in the present disclosure, the obtaining module is specifically configured to:
upon rotation of the extended reality device by a preset angle each time, capture an environmental scene to obtain the keyframe image and the depth image.

According to one or more embodiments of the present disclosure, in the image processing apparatus provided in the present disclosure, the processing module includes:
a first processing unit, configured to process the environmental keyframe image to obtain a radiance map:
a second processing unit, configured to process the depth image to obtain a normal vector map;
a calculation unit, configured to calculate based on a preset internal parameter matrix and pixel coordinates of the radiance map to obtain a direction vector of a texture model:
a determination and obtaining unit, configured to determine a pixel radiance value based on the radiance map, and obtain a normal vector based on the normal vector map:
the calculation unit, configured to calculate based on the pixel radiance value, the direction vector, and the normal vector to obtain a lighting intensity and a lighting color of each azimuth coordinate of the texture model; and
a determination unit, configured to determine the lighting model based on the lighting intensity and the lighting color of each azimuth coordinate of the texture model.

According to one or more embodiments of the present disclosure, in the image processing apparatus provided in the present disclosure, the processing module further includes:
an obtaining unit, configured to obtain a shooting position corresponding to the radiance map and the depth map; and
a conversion unit, configured to, in response to the shooting position being not a preset standard position, convert coordinates of the radiance map and of the depth image to obtain a new radiance map and a new depth image, and use the new radiance map as the radiance map and use the new depth image as the depth image.

According to one or more embodiments of the present disclosure, in the image processing apparatus provided in the present disclosure, the first processing unit is specifically configured to:
obtain a color channel corresponding to the environmental keyframe image, and process the color channel based on a calibration mapping table corresponding to each color channel to obtain the radiance map.

According to one or more embodiments of the present disclosure, in the image processing apparatus provided in the present disclosure, the second processing unit is specifically configured to:
calculate, based on depth values and pixel coordinates of the depth image, a normal vector on a three-dimensional space object corresponding to each pixel to obtain the normal vector map.

According to one or more embodiments of the present disclosure, in the image processing apparatus provided in the present disclosure, the calculation unit is specifically configured to:
establish a to-be-solved lighting function based on the pixel radiance value, the direction vector, the normal vector, the lighting intensity, and the lighting color:
convert the to-be-solved lighting function to obtain a target lighting function:
obtain a target energy function based on the target lighting function and discretized azimuth degrees; and
calculate the target energy function to obtain the lighting intensity and the lighting color of each azimuth coordinate of the texture model.

According to one or more embodiments of the present disclosure, the present disclosure provides an electronic device, including:
a processor; and
a memory configured to store executable instructions for the processor,
where the processor is configured to read the executable instructions from the memory, and execute the instructions to implement the image processing method according to any one of the present disclosure.

According to one or more embodiments of the present disclosure, the present disclosure provides a computer-readable storage medium, where the storage medium stores a computer program, and the computer program is configured to implement the image processing method according to any one of the present disclosure.

Some embodiments of the present disclosure further provide a computer program product, including a computer program/computer instructions, where the computer program/computer instructions, when executed by a processor, implement the image processing method provided in any one of the embodiments of the present disclosure.

Some embodiments of the present disclosure further provide a computer program/computer instructions, where the computer program/computer instructions, when executed by a processor, implement the image processing method provided in any one of the embodiments of the present disclosure.

The foregoing description is merely preferred embodiments of the present disclosure and explanations of the applied technical principles. A person skilled in the art should understand that the scope of disclosure involved in the present disclosure is not limited to the technical solution formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features having similar functions disclosed in the present disclosure (but not limited thereto).

In addition, although the various operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An image processing method, comprising:
obtaining an environmental keyframe image and a corresponding depth image captured by an extended reality device;
determining a lighting model based on the environmental keyframe image and the depth image; and
rendering an extended reality object to be rendered based on the lighting model.

2. The image processing method according to claim 1, wherein the obtaining an environmental keyframe image and the corresponding depth image captured by the extended reality device comprises:
upon rotation of the extended reality device by a preset angle each time, capturing an environmental scene to obtain the environmental keyframe image and the corresponding depth image.

3. The image processing method according to claim 1, wherein the determining the lighting model based on the environmental keyframe image and the depth image comprises:
processing the environmental keyframe image to obtain a radiance map, and processing the depth image to obtain a normal vector map;
calculating based on a preset internal parameter matrix and pixel coordinates of the radiance map to obtain a direction vector of a texture model;
determining a pixel radiance value based on the radiance map, and obtaining a normal vector based on the normal vector map;
calculating based on the pixel radiance value, the direction vector, and the normal vector to obtain a lighting intensity and a lighting color of each azimuth coordinate of the texture model; and
determining the lighting model based on the lighting intensity and the lighting color of each azimuth coordinate of the texture model.

4. The image processing method according to claim 3, wherein before the processing the depth image to obtain the normal vector map, the image processing method further comprises:
obtaining a shooting position corresponding to the radiance map and the depth map; and
in response to the shooting position being not a preset standard position, converting coordinates of the radiance map and of the depth image to obtain a new radiance map and a new depth image, and using the new radiance map as the radiance map and using the new depth image as the depth image.

5. The image processing method according to claim 3, wherein the processing the environmental keyframe image to obtain the radiance map comprises:
obtaining one or more color channels corresponding to the environmental keyframe image, and processing each of the one or more color channels based on a respective calibration mapping table to obtain the radiance map.

6. The image processing method according to claim 3, wherein the processing the depth image to obtain the normal vector map comprises:
calculating, based on depth values and pixel coordinates of the depth image, a normal vector on a three-dimensional space object corresponding to each pixel to obtain the normal vector map.

7. The image processing method according to claim 3, wherein the calculating based on the pixel radiance value, the direction vector, and the normal vector to obtain the lighting intensity and the lighting color of each azimuth coordinate of the texture model comprises:
establishing a to-be-solved lighting function based on the pixel radiance value, the direction vector, the normal vector, the lighting intensity, and the lighting color;
converting the to-be-solved lighting function to obtain a target lighting function;
obtaining a target energy function based on the target lighting function and discretized azimuth degrees; and
calculating the target energy function to obtain the lighting intensity and the lighting color of each azimuth coordinate of the texture model.

8-11. (canceled)

12. An electronic device, wherein the electronic device comprises:
a processor; and
a memory configured to store executable instructions for the processor,
where the processor is configured to read the executable instructions from the memory, and execute the executable instructions to implement the image processing method comprising:
obtaining an environmental keyframe image and a corresponding depth image captured by an extended reality device;
determining a lighting model based on the environmental keyframe image and the depth image; and
rendering an extended reality object to be rendered based on the lighting model.

13. A computer-readable storage medium, wherein the storage medium stores a computer program, and the computer program is configured to implement the image processing method comprising:
obtaining an environmental keyframe image and a corresponding depth image captured by an extended reality device;
determining a lighting model based on the environmental keyframe image and the depth image; and
rendering an extended reality object to be rendered based on the lighting model.

14. (canceled)

15. The electronic device according to claim 12, wherein the obtaining an environmental keyframe image and the corresponding depth image captured by the extended reality device comprises:
upon rotation of the extended reality device by a preset angle each time, capturing an environmental scene to obtain the environmental keyframe image and the corresponding depth image.

16. The electronic device according to claim 12, wherein the determining the lighting model based on the environmental keyframe image and the depth image comprises:
processing the environmental keyframe image to obtain a radiance map, and processing the depth image to obtain a normal vector map;
calculating based on a preset internal parameter matrix and pixel coordinates of the radiance map to obtain a direction vector of a texture model;
determining a pixel radiance value based on the radiance map, and obtaining a normal vector based on the normal vector map;
calculating based on the pixel radiance value, the direction vector, and the normal vector to obtain a lighting intensity and a lighting color of each azimuth coordinate of the texture model; and
determining the lighting model based on the lighting intensity and the lighting color of each azimuth coordinate of the texture model.

17. The electronic device according to claim 16, wherein before the processing the depth image to obtain the normal vector map, the image processing method further comprises:
obtaining a shooting position corresponding to the radiance map and the depth map; and
in response to the shooting position being not a preset standard position, converting coordinates of the radiance map and of the depth image to obtain a new radiance map and a new depth image, and using the new radiance map as the radiance map and using the new depth image as the depth image.

18. The image processing method according to claim 3, wherein the processing the environmental keyframe image to obtain the radiance map comprises:
obtaining one or more color channels corresponding to the environmental keyframe image, and processing each of the one or more color channels based on a respective calibration mapping table to obtain the radiance map.

19. The electronic device according to claim 16, wherein the processing the depth image to obtain the normal vector map comprises:
calculating, based on depth values and pixel coordinates of the depth image, a normal vector on a three-dimensional space object corresponding to each pixel to obtain the normal vector map.

20. The electronic device according to claim 16, wherein the calculating based on the pixel radiance value, the direction vector, and the normal vector to obtain the lighting intensity and the lighting color of each azimuth coordinate of the texture model comprises:
establishing a to-be-solved lighting function based on the pixel radiance value, the direction vector, the normal vector, the lighting intensity, and the lighting color;
converting the to-be-solved lighting function to obtain a target lighting function;
obtaining a target energy function based on the target lighting function and discretized azimuth degrees; and
calculating the target energy function to obtain the lighting intensity and the lighting color of each azimuth coordinate of the texture model.

21. The computer-readable storage medium according to claim 13, wherein the obtaining an environmental keyframe image and the corresponding depth image captured by the extended reality device comprises:
upon rotation of the extended reality device by a preset angle each time, capturing an environmental scene to obtain the environmental keyframe image and the corresponding depth image.

22. The computer-readable storage medium according to claim 13, wherein the determining the lighting model based on the environmental keyframe image and the depth image comprises:
processing the environmental keyframe image to obtain a radiance map, and processing the depth image to obtain a normal vector map;
calculating based on a preset internal parameter matrix and pixel coordinates of the radiance map to obtain a direction vector of a texture model;
determining a pixel radiance value based on the radiance map, and obtaining a normal vector based on the normal vector map;
calculating based on the pixel radiance value, the direction vector, and the normal vector to obtain a lighting intensity and a lighting color of each azimuth coordinate of the texture model; and
determining the lighting model based on the lighting intensity and the lighting color of each azimuth coordinate of the texture model.

23. The computer-readable storage medium according to claim 22, wherein before the processing the depth image to obtain the normal vector map, the image processing method further comprises:
obtaining a shooting position corresponding to the radiance map and the depth map; and
in response to the shooting position being not a preset standard position, converting coordinates of the radiance map and of the depth image to obtain a new radiance map and a new depth image, and using the new radiance map as the radiance map and using the new depth image as the depth image.

24. The computer-readable storage medium according to claim 22, wherein the processing the environmental keyframe image to obtain the radiance map comprises:
obtaining one or more color channels corresponding to the environmental keyframe image, and processing each of the one or more color channels based on a respective calibration mapping table to obtain the radiance map.

25. The computer-readable storage medium according to claim 22, wherein the processing the depth image to obtain the normal vector map comprises:
calculating, based on depth values and pixel coordinates of the depth image, a normal vector on a three-dimensional space object corresponding to each pixel to obtain the normal vector map.
